(19) United States
(12) Patent Application Publication
(10) Pub. No.: US 2008/0225940 A1
(43) Pub. Date: Sep. 18, 2008

(54) DIGITAL VIDEO APPARATUS AND METHOD THEREOF FOR VIDEO PLAYING AND RECORDING

(76) Inventors: Chen Ma, San Jose, CA (US); Chih-Pin Wu, Yun-Lin County (TW)

Correspondence Address: NORTH AMERICA INTELLECTUAL PROPERTY CORPORATION, P.O. BOX 506, MERRIFIELD, VA, 22116, US

(21) Appl. No.: 11/956,276

(22) Filed: Dec. 13, 2007

Related U.S. Application Data
(60) Provisional application No. 60/895,147, filed on Mar. 16, 2007.

(51) Int. Cl. H04N 11/02

(52) U.S. Cl. 375/240.01; 375/E07.076

(57) ABSTRACT

A digital video apparatus and method thereof are disclosed. The digital video apparatus includes: a first decoder, for receiving an input video signal and decoding the input video signal to generate a transformed video signal; a processor, for processing the transformed video signal, and accessing the transformed video signal in a storage device; and a first encoder, for receiving the transformed video signal, encoding the transformed video signal and outputting an encoded transformed video signal.

### CROSS REFERENCE TO RELATED APPLICATIONS

This application claims the benefit of U.S. Provisional Application No. 60/895,147, filed on Mar. 16, 2007 and entitled “DIGITAL VIDEO APPARATUS AND METHOD THEREOF FOR VIDEO PLAYING AND RECORDING”, the contents of which are incorporated herein by reference.

### BACKGROUND OF THE INVENTION

1. Field of the Invention

The present invention relates to video technology, and in particular, relates to a digital video apparatus for image recording and playing.

2. Description of the Prior Art

Digital video applications are commonplace in everyday life. Advancements in video applications and tools have led to the advent of the digital video recorder (DVR). A user may desire to playback previous video or review important or favorite portions of the video data, and the digital video recorder can satisfy such needs.

However, most currently available digital video recorders do not support real-time video playing; that is, there is a delay between the receiving and the outputting for viewing of the input video signal, and therefore the output video images that the user watches are not genuinely “real-time”. Such a delay is a common phenomenon for traditional digital video apparatuses. The reason this occurs is that the video content displayed by current digital video decoders is always stored video data. The video signal received from the audio-video data source undergoes compression or other processing before being stored to a storage device, and the stored video data then undergoes decompression or other steps before it can be viewed by users. Due to these many processing steps before actual playing, a significant amount of delay therefore exists between the receipt and display of the video data, which can reach as many as several seconds or even more than ten seconds. Thus, the video data is far from being “real-time” displayed.

Sometimes a user may desire or need to get real-time video information; for example, sport games, premiere movie showings, or political/economic information. Therefore, it is important to jointly provide both video playback and real-time video display, such that a user can playback previous video and display real-time video according to his/her needs. In this way a better and more versatile video service can be provided.

### SUMMARY OF THE INVENTION

One objective of the present invention is to provide a digital video apparatus for real-time displaying and a method thereof, such that the video can be displayed in real-time to solve the above-mentioned problems.

The present invention provides a digital video apparatus capable of displaying video in real-time. The apparatus and method not only can provide real-time video display, but can also provide playback and pause functionality. The user can therefore obtain the newest video information by the provided real-time video, and pause the video for later display. Thereby the watched video can be played back an unlimited number of times within a specific period of time. The present invention can therefore solve the above-mentioned problems to improve the video viewing experience. As mentioned above, it is apparent that the present invention is a novel invention.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a digital video apparatus according to one embodiment of the present invention.

FIG. 2 is a diagram illustrating the processing path of the digital video apparatus shown in FIG. 1 displaying received video data according to one embodiment of the present invention.

FIG. 3 is a diagram illustrating a plurality of image files of the same content.

FIG. 4 is a diagram illustrating the corresponding relations between an index and a video file according to one embodiment of the present invention.

FIG. 5 is a diagram illustrating the content of the index shown in FIG. 4 according to one embodiment of the present invention.

FIG. 6 is a diagram illustrating the corresponding relations between the video content displayed by the digital video apparatus shown in FIG. 1 and the image files according to one embodiment of the present invention.

### DETAILED DESCRIPTION

A digital recorder and/or a main device containing a DVR controller chip are taken as examples for describing the embodiments of the present invention in the following description. They are not, however, intended to be limitations of the present invention. As known by persons skilled in the art, the method according to the present invention can be applied to other digital video apparatus, including recording/displaying functions or an above-mentioned DVR controller chip. For example, a digital set-top box, a digital television, or a game player also fall within the scope of the present invention.

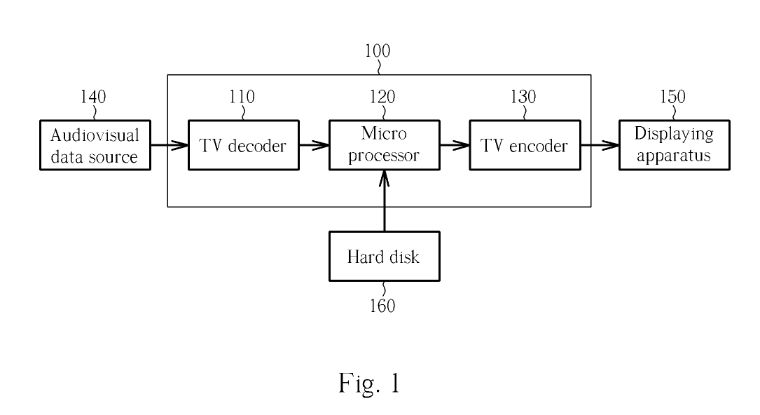

FIG. 1 is a diagram illustrating a digital video apparatus according to one embodiment of the present invention. As shown in FIG. 1, the digital video apparatus 100 comprises a TV decoder 110, a microprocessor 120, and a TV encoder 130. It should be noted that the digital video apparatus 100 can further comprise other devices such as audio I/O interface, Ethernet module, IEEE 1394 interface, USB interface, DDR control module, flash memory control module, and other interface modules by demand.

In this embodiment, the digital video 100 is coupled to an audiovisual data source 140 (for example, the audiovisual bit stream, or a TV signal) via a TV decoder 110. The TV decoder 110 is used for receiving and decoding a video signal from the audiovisual data source 140. For example, a TV decoder 110 can be used for receiving an analog NTSC, PAL and/or SECAM baseband video signal, and for decoding to a format of YUV 4:2:2 digital video signal; in this embodiment, the TV decoder 110 comprises four ten-bit ADCs, and comprises 2D and 3D comb filters to perform YC separation. The microprocessor 120 is coupled to a TV decoder 110, a TV encoder 130 and a high capacity data storage device such as a hard disk 160. The microprocessor 120 is used for processing the video signal decoded by the TV decoder 110 and accessing the hard disk 160, thereby transmitting the processed video signal to the TV encoder 130. In this embodiment, the microprocessor 120 consists of at least one digital signal processing circuit and/or a micro processing circuit (such as MIPS). The TV encoder 130, which is coupled to the microprocessor 120 and to a displaying apparatus 150 (for example, a displaying screen of a TV or a monitor), is used for encoding the video signal processed by the microprocessor 120. For example, the TV encoder encodes a digital CR-Y-CB 4:2:2 video signal into standard TV signals such as NTSC, PAL CVBS, S-Video, YUV or RGB. In this embodiment, the TV encoder 130 comprises six 12 bit ADCs.

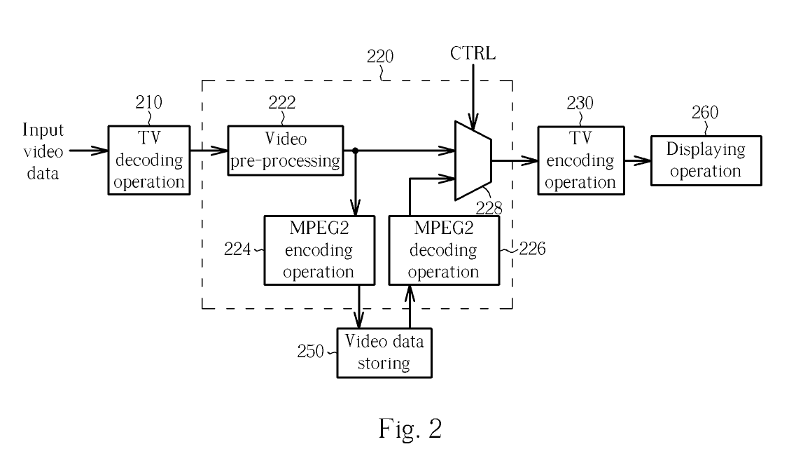

FIG. 2 is a diagram illustrating the processing path of the digital video apparatus 100 displaying received video data according to one embodiment of the present invention. In the figure, each block indicates the process or operation of the device shown in FIG. 1, which will be described as below. After the digital video apparatus 100 receives a digital signal from the audiovisual data source 140, the TV decoder 110 first performs a TV decoding operation 210 as described above. After the TV decoding operation 210 is finished, the TV decoder 110 transmits the transformed video signal to the microprocessor 120, which performs video pre-processing 222 on the signal. Normally, the pre-processing performs a filtering operation and/or other image processing operations to decrease or eliminate noise introduced during transmission. After pre-processing, the video signal enters two different processing paths. In the first path, the pre-processed video signal (e.g., the transformed video signal) is directly transmitted to the TV encoder 130 in the first path to perform a TV encoding operation 230 to encode the transformed video signal into an encoded transformed video signal, as described above, and then, the encoded transformed video signal is transmitted to the displaying apparatus 150 for a displaying operation 260. In the second path, the pre-processed video signal is processed by the microprocessor 224 for MPEG2 encoding or other data compression in order to compress the data for storing on the hard disk 160 (that is, the video data storage operation 250). The stored data (in compressed form) will be read out as required, and the microprocessor 120 performs a MPEG2 decoding operation 226 to return the data to an uncompressed video signal. Then the decompressed video signal undergoes the TV encoding operation 230 and the displaying operation 260.

It should be noted that the microprocessor 120 also adds a timestamp to the stored video signal (e.g., the encoded video signal stored in hard disk 160) during compression in the second path, thereby allowing the digital video apparatus 100 to identify the image timing accurately. The technique for adding timestamps to a video signal is well known by persons skilled in the art, thus it is omitted for brevity.

As described above, the embodiment of the present invention does not utilize the prior art processing method, which reads stored video data and displays it, and causes a time delay, which may be greater than several seconds while watching live content. The embodiment of the present invention provides a video signal processing path (e.g., the first path mentioned above) that can directly output the video signal and display it without going through the steps of compressing/encoding, writing to storage, retrieving from storage, and decompressing/decoding; the user can watch “true real-time” video content, and does not need to suffer extra delays for compressing encoding and hard disk accessing. Such a feature is especially meaningful for the user who has high demand for real-time video (for example, sports games or premiere movie showings).

The user may wish to watch real-time content, but also pause, replay, and/or rewind or seek through the displayed content. Thus, the embodiment of the present invention also provides a second path for compressing and storing the video signal after pre-processing besides the first path for real-time displaying. For example, if a user does not want to lose video content while pausing real-time video (for example, pressing the “pause” button), he or she can give the digital video apparatus a suitable order (for example, pressing the “play” button). Simultaneously the microprocessor 120 generates a corresponding control signal CTRL to select the video signal (via a multiplexer 228 in this embodiment) from the hard disk 160 and, after being MPEG2 decoded, displays the content immediately following the paused position in the video content. Similarly, if a user wants to rewind or search past content, he/she can perform a suitable operation on the digital image apparatus (such as pressing the “rewind” button or manipulating the jog/shuttle controller). The microprocessor 120 generates a corresponding control signal CTRL to select the video signal (via a multiplexer 228 in this embodiment) from the hard disk 160 and, after being MPEG2 decoded, displays the video content corresponding to the timing position set by the user.

Of course, the user can return to real-time video content by performing a specific operation on the video system (for example, pressing the “live” button). The microprocessor 120 generates a corresponding control signal CTRL to select the video signal after the pre-processing 222, which has not been compressed and stored, such that real-time video content will be displayed again.

It should be noted that, although the TV decoding operation 210 and the TV encoding operation 230 are performed via a dedicated TV decoder circuit and a TV encoder circuit, this embodiment is for illustrative purposes only and is not intended to be a limitation of the present invention. Similarly, while the video pre-processing 222, the MPEG2 encoding operation and the MPEG2 decoding operation are performed by a microprocessor 120 co-operating with software or firmware, this is not intended to be a limitation of the present invention. As known by persons skilled in the art, the above-mentioned processing operations and functions can be performed by other circuits and/or software. Furthermore, in this embodiment, the digital video apparatus 100 comprises a TV decoder 110 for transforming an analog video signal to a digital video signal, and a TV encoder 130 for transforming the digital video signal to the analog video signal, but this is not intended to be a limitation of the present invention; the TV decoder 110 can be removed if the signal from the audiovisual data source 140 is originally in digital form, and the TV encoder 130 can be removed if the displaying apparatus 150 includes a digital signal interface for receiving the digital video signal. Also, the hard disk 160 may be a storage medium that is dependent or independent from the digital video apparatus 100, but this is not a limitation of the present invention. For example, a remote apparatus that can be connected via a network (such as the Internet) also falls within the scope of the present invention. In addition, the digital video apparatus 100 performs video compression before storing the video signal to save bandwidth or storage space in this embodiment, but this does not limit the scope of the present invention. In other embodiments, the video signal can be directly stored to the hard disk 160 without compression.

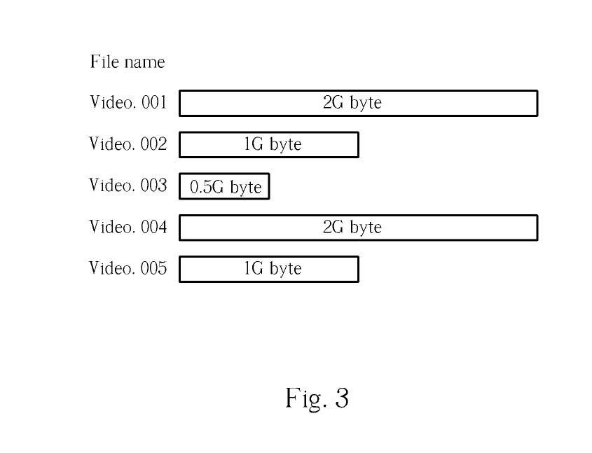

FIG. 3 is a diagram illustrating a plurality of image files of the same content (for example, the same movie). The image files are stored in the hard disk 160 of the digital video apparatus 100 or received via the network or other data sources. As shown in FIG. 3, the video information of the same content is stored to five files in this sequence: “video.001” with 2 G byte, “video.002” with 1 G byte, “video.003” with 0.5 G byte, “video.004” with 2 G byte, “video.005” with 1 G byte. The timing of information stored in the “video.002” follows the timing of the “video.001”, the timing of information stored in the “video.003” follows the timing of the “video.002”, and so on. Since the size of each single file may be limited by the encoding technique (as in DivX, for example) or by the file system (like FAT32, for example), the video information must be separated into several files. The video information may be separated into a plurality of files when being received from a data source (for example, data transmission over the Internet), or it can be separated into a plurality of files when the microprocessor 120 compresses and encodes the video data in timing sequence, and then, they are stored in the hard disk 160.

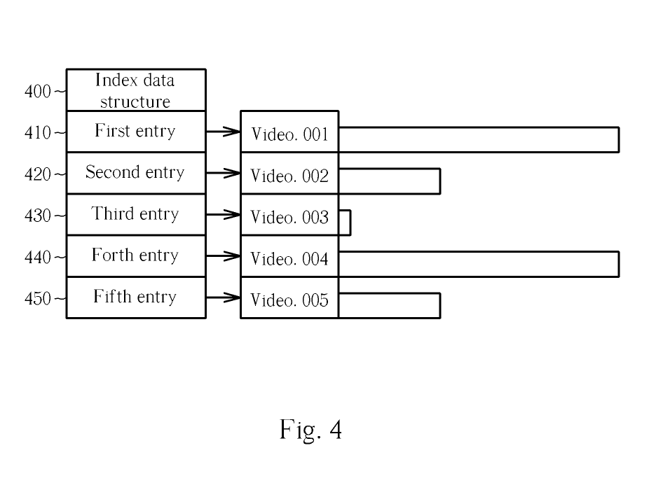

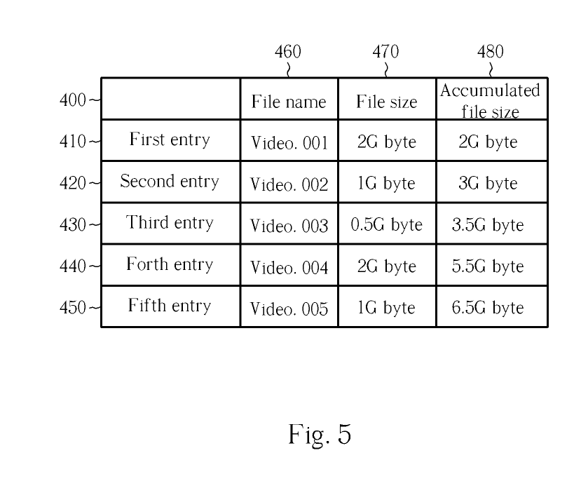

According to the embodiment of the present invention, when the digital video apparatus 100 forms the above-mentioned image files belonging to the same concept, the digital video apparatus 100 stores the image files to the hard disk 160, but also generates an index for the image files, as shown in FIG. 4. FIG. 4 is a diagram illustrating the corresponding relations between the index 400 and the above-mentioned video file according to one embodiment of the present invention. As shown in FIG. 4, the index 400 includes a plurality of entries, and each of the entries corresponds to one of the above-mentioned image files. For example, the first entry 410 corresponds to “video.001”, the second entry to “video.002”, and so on. FIG. 5 is a diagram illustrating the content of the index 400 shown in FIG. 4 according to one embodiment of the present invention. Corresponding to each entry, the index 400 comprises a “file name” field 460, a “file size” field 470, and selectively comprises an “accumulated file size” field 480.

The “file name” field 460 is used to indicate the file names of each file according to the timing order of the video data content. For example, as shown in FIG. 5, the “file name” field of the first entry is “video.001”, the “file name” field of the second entry is “video.002”, and the “file name” field of the fifth entry is analogized “video.005”. The “file size” field 470 is used for indicating the file size of the file names corresponding to each entry. As shown in FIG. 5, the “file size” field of the first entry is 2 G byte, i.e. the size of “video.001” is 2 G byte. Also, the “file size” field of the second entry is 1 G byte, i.e. the size of “video.002” is 1 G byte. Similarly, the “file size” field of the fifth entry is 1 G byte, i.e. the size of “video.005” is 1 G byte. The “accumulated file size” field 480 is used for indicating accumulated file size since the first entry. For example, as shown in FIG. 5, the “accumulated file size” fields 480 of the first through fifth entries are 2 G byte, 3 G byte, 3.5 G byte, 5.5 G byte, and 6.5 G byte respectively.

In this embodiment, the digital video apparatus 100 will search for the stored image files at certain instances; for example, when initializing or opening specific file directories. Also, the digital video apparatus 100 finds files with the same file characteristics (for example, files with “video” heading in this embodiment), fill the index 400 with related information of these files, and buffers the index 400 to a memory space (for example, a DRAM, which is not shown in the figures). It should be noted that the disclosed method for generating and maintaining an index file is only an example and is not intended to be a limitation of the scope of the present invention. Persons skilled in the art can use other methods for generating or maintaining an index file, which also falls within the scope of the present invention.

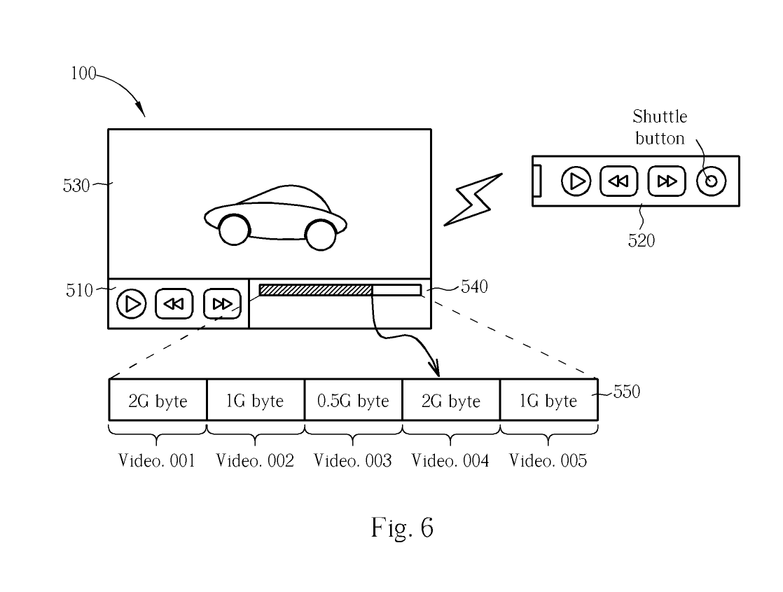

Since the digital video apparatus 100 can generate and maintain the index 400 as shown in FIG. 6, the digital video apparatus 100 can easily find where the current displayed image is located and which image file is being accessed via reading the information stored in the index 400 and computing index, then access the memory location of the indicated file to correctly display the video content. FIG. 6 is a diagram illustrating the corresponding relations between the video content displayed by the digital video apparatus 100 and the image files according to one embodiment of the present invention. As shown in FIG. 6, the digital video apparatus 100 comprises an operation interface 510, a remote operation interface 520, and a displaying screen 530. In this embodiment, the operation interface 510 comprises popular operation functions for controlling video playback: buttons for “play”, “rewind”, “fast forward”, or other functions, for example. The remote operation interface 520 (for example, a remote controller) can comprise the above-mentioned operation buttons, but can also comprise a jog/shuttle controller for quickly searching desired video content. In FIG. 6, a slider or time bar 540 is further included, which can be dragged for determining the position of the video content to be displayed. The time bar 540 can be a part of the operation interface of the digital video apparatus 100, but the time bar 540 can be omitted from the operation interface and simply indicate the time index for indicating the current position of video content.

When the video content is normally displayed (for example, a user pushes the play button), the digital video apparatus 100 maintains a time counting value for indicating the timing position of the video content currently displayed. The video content can be displayed in sequence via increasing the time counting value. As shown in FIG. 6, there is a one-to-one corresponding relation between the time bar 540 for time indicator and the content index 550 indicating the file locations. Since there is a corresponding relation between the position of the video content and the image files' storage location, the time counting value maintained by the digital video apparatus 100 can be transformed to a corresponding data location. Then a searching and comparing step is performed via the index 400 shown in FIG. 5, such that the location of the video currently displayed content can be obtained.

For example, the displayed video position is at one hour twenty-five minutes when the user pushes the play button. The data location corresponding to the current position lies between (2 Gbyte+1 Gbyte+0.5 Gbyte)=3.5 Gbyte and (2 Gbyte+1 Gbyte+0.5 Gbyte+2 Gbyte)=5.5 Gbyte. That is, the current position in file “video.004”, which can be obtained by transforming the timing/data amount and searching and comparing against the index 400 (for example, comparing and searching the “file size” field 470). The precise location of the data in file “video.004” can be obtained via a transforming equation or ratio relation. In this way, the digital video apparatus 100 can correctly access the video data in “video.004” and display it. Alternatively, the method can directly search or compare the “accumulated file size” field 480. Similarly, the playback position enters the data location of the next file (for example, two hours ten minutes into the video). The data location corresponding to that current timing in the file “video.005” can be obtained by transforming the timing/data amount and searching and comparing against the index 400, and the digital video apparatus 100 can correctly access the video data in “video.005” and display it.

The advantage of the present invention is more apparent when the displayed video content is rewound or searched, especially when rewinding or searching across files, for example, when the rewind button is pressed, or when the user is operating the jog/shuttle controller on the remote controller 520, or when the user is dragging a cursor on the time bar 540. In the previous example, the displayed position is at one hour twenty-five minutes of video, and the corresponding data location is in file “video.004”. In this case, if the playback position is changed to one hour five minutes into the video via a rewinding or searching operation, the data location corresponding to the current timing in the file “video.003” can be obtained by transforming the timing/data amount and searching and comparing against the index 400, and the digital video apparatus 100 can correctly access the video data in the “video.003” to display it. It should be noted that the digital video apparatus 100 originally reads data from the file “video.004” and then reads data from the file “video.003” in the rewinding or searching operation of the embodiment; such a cross-file operation, especially a backward cross-file operation cannot be performed by the prior art. However, such an operation can be easily accomplished with the index 400 according to the embodiment of the present invention, co-operating with some simple file content searching and comparing operations.

It should be noted that, although the index 400 is used for storing the file size or the accumulated file size in the above-mentioned embodiment, this is not intended to be a limitation of the present invention. As known by persons skilled in the art, the index 400 can also store time stamps corresponding to the start or end times of the file content, and the same effect can also be reached in this way. Moreover, since each entry arranges the data according to file names and file sizes (or time stamp), the file names for image files of the same content (for example, a movie) stored in the digital video apparatus 100 utilizing the index 400 of the present invention do not need any specific stoke or word numbers. The digital video apparatus 100 needs only to search the index 400 to find the correct image files.

As mentioned above, the embodiment according to the present invention discloses a digital video apparatus 100 generating and maintaining an index 400 with small size, such that seamless cross-file video searching and display can be obtained. In this way, the problem of the prior art can be avoided, where the user must suffer stops or delays when displaying across files, or where backward seeking or displaying operations across files cannot be performed at all. The software applied to the digital video apparatus 100 utilizing the index 400 of the present invention can be designed to only manage and show the index 400, thereby allowing the user to see only the information in a content-based form instead of in a file-based form. Thereby the interface management of the application software can be simpler and friendlier.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A digital video apparatus, comprising:
a first decoder, for receiving an input video signal and decoding the input video signal to generate a transformed video signal;
a processor, for processing the transformed video signal, and accessing the transformed video signal in a storage device; and
a first encoder, for receiving the transformed video signal, encoding the transformed video signal and outputting an encoded transformed video signal.

2. The apparatus of claim 1, wherein the processor further comprises:
a first path, for receiving the transformed video signal and outputting the transformed video signal in real-time;
a second path, for receiving and encoding the transformed video signal into an encoded video signal, and storing the encoded video signal, wherein the second path further decodes the encoded video signal into the transformed video signal, and outputs the transformed video signal after being turned on; and
a multiplexer, for selecting one of the first path and the second path for outputting the transformed video signal from the first path and the transformed video signal from the second path according to a control signal.

3. The apparatus of claim 2, wherein the second path further comprises:
a second encoder, for receiving and encoding the transformed video signal to generate the encoded video signal that is stored to the storage device; and
a second decoder, for retrieving the encoded video signal from the storage device, decoding the encoded video signal that is retrieved by the second decoder to generate the transformed video signal, and feeding the transformed video signal to the multiplexer according to the control signal.

4. The apparatus of claim 1, wherein the processor further comprises:
a pre-processing unit, for performing a filtering operation or another image processing operation on the transformed video signal to decrease or eliminate noise during transmission.

5. The apparatus of claim 2, wherein the output signal is from the first path before the second path is selected.

6. The apparatus of claim 2, wherein the output signal is from the second path if the second path is selected.

7. The apparatus of claim 1, wherein the processor stores the transformed video signals of the same video data as a plurality of files in sequence, and generates an index for indicating at least one of the files.

8. The apparatus of claim 7, wherein the index includes at least one of file name or file size of the files.

9. The apparatus of claim 7, wherein the index includes accumulated file sizes of the files.

10. The apparatus of claim 7, wherein the processor performs a searching and a comparing operation to determine a first video film of the files to be read and the location of the first video film according to the index.

11. The apparatus of claim 7, wherein the processor performs the searching and the comparing operation to determine a first video film of the files to be read and the orders and locations of the files to be read following the first video film according to the index.

12. A digital video method, for recording and displaying video, comprising:
receiving a video signal;
outputting the video signal in real-time;
encoding the video signal to generate an encoded video signal;
storing the encoded video signal as a stored encoded video signal;
pausing a frame of the video signal according to a control signal;
ending the real-time video signal outputting according to the control signal; and
determining to perform play backing mode or keep pausing according to the control signal, wherein the outputting of the play backing mode is from the real-time video outputting or the outputting of the stored encoded video signal.

13. The method of claim 12, wherein the step of storing the encoded video signal further comprising:
encoding the input video signal in sequence to generate a plurality of encoded files;
storing the encoded files in sequence; and
generating an index for indicating the encoded files.

14. The method of claim 13, wherein the index includes file names of the encoded files.

15. The method of claim 13, wherein the index includes file sizes of the encoded files.

16. The method of claim 13, wherein the index includes accumulated file sizes of the encoded files.

17. The method of claim 13, wherein the index is used for comparing and searching to determine a first video film of the encoded files to be read and the location of the first video film.

18. The method of claim 13, wherein the index is used for comparing and searching to determine a first video film of the encoded files to be read and the orders and locations of the encoded files to be read following the first video film.

19. A digital video apparatus, the apparatus comprising:
a first path, for receiving a video signal and outputting the video signal in real-time;
a second path, for receiving and encoding the video signal into an encoded video signal, and storing the encoded video signal, wherein the second path further decodes the encoded video signal into the video signal, and outputs the video signal after being turned on; and
a multiplexer, for selecting one of the first path and the second path for outputting the video signal from the first path and the video signal from the second path according to a control signal.

20. The apparatus of claim 19, further comprises:
a first decoder, coupled to the first path and the second path, for receiving an input video signal and decoding the input video signal to generate the video signal; and
a first encoder, coupled to the first path and the second path, for receiving the video signal, encoding the video signal and outputting an output video signal.

21. The apparatus of claim 19, wherein the second path further comprises:
a second encoder, for receiving and encoding the video signal to generate the encoded video signal that is stored to a storage device;
a second decoder, for retrieving the encoded video signal from the storage device, decoding the encoded video signal to generate the video signal, and feeding the video signal to the multiplexer according to the control signal; and
a pre-processing unit, for performing a filtering operation or another image processing operation on the video signal to decrease or eliminate noise during transmission.

22. The apparatus of claim 20, wherein the output video signal is from the first path before the second path is selected, and the output video signal is from the second path if the second path is selected.

23. The apparatus of claim 19, wherein the second path stores the encoded video signals of the same video data as a plurality of files in sequence, and generates an index for indicating at least one of the files.

24. The apparatus of claim 23, wherein the index includes file names of the files, file sizes of the files, and accumulated file sizes of the files.

25. The apparatus of claim 23, wherein the second path performs a searching and a comparing operation to determine a first video film of the files to be read, the location of the first video film, and the orders and locations of the files to be read following the first video film according to the index.
